(19) United States
(12) Patent Application Publication
(10) Pub. No.: US 2008/0295171 A1
(43) Pub. Date: Nov. 27, 2008

(54) Intrusion Detection System For Wireless Networks

(75) Inventors: Abhishek Kumar Singh, Bangalore (IN); Gaurav Kumar, Modinagar (IN); Sudarshan Yermal, Bangalore (IN); Kartikeya Sriniwas Ramanathan, Bangalore (IN); Denis Foo Kune, Saint Paul, MN (US); Channabasavaraj Raravi, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NE (US)

(21) Appl. No.: 11/752,308

(22) Filed: May 23, 2007

(51) Int. Cl. G08B 23/00

(52) U.S. Cl. 726/23

(57) ABSTRACT

A wireless node in a wireless network examines data packets directed to itself (i.e., value in destination address field indicates that the wireless node is an intended recipient)for presence of anomalies that suggest intrusion. The data packet is examined as part of the normal course of operation of the node. Upon detection of an anomaly, the wireless node sends a message packet containing details of the anomaly to a sentinel device. The sentinel device processes the anomalies to determine if a possibility of intrusion is indicated, and activates a spy routine in the wireless node. The spy routine enables further investigation into the intrusion. As components (such as wireless nodes) in the wireless network operate normally (normal operations) until an anomalous condition/event occurs, the additional power requirements for intrusion detection are reduced. If intrusion is detected, appropriate actions, such as alerting an operator, are taken to mitigate the intrusion.

### BACKGROUND OF THE INVENTION

1. Technical Field

The present disclosure relates generally to security in wireless networks, and more specifically to an intrusion detection system for wireless networks.

2. Related Art

A wireless network generally refers to a communication network formed by devices communicating wirelessly (over a wireless medium). Some examples of wireless networks include wireless local area network (WLAN), cellphone network, etc.

Wireless devices forming part of the wireless network generally connect to (and operate in) the network without requiring to be in a fixed (or known) location, unlike in a wired network where the devices generally are located at known connection points in the network. Consequently, there is generally an enhanced probability (compared to wired networks) for an unauthorized or “rogue” wireless device to connect to the network.

Such “intrusion” in a wireless network is generally undesirable, and an intrusion detection system (IDS) may be employed in a wireless network to detect and/or prevent such intrusion.

In a prior intrusion detection system (IDS), a wireless security component is deployed in the wireless network, with the wireless security device monitoring all (or most of) the communication traffic (packets) received on the network. For example, the security component may store the packets and then analyze the stored packets to determine any anomalies suggesting possible intrusion.

One problem with such an approach is that a wireless security component may consume substantial amount of power even when no intrusion occurs, since the packets on the wireless network are being constantly monitored. Such power constraints, and/or additional computations needed for continuous monitoring are of particular concern in environments such as industrial process control systems employing wireless devices.

### BRIEF DESCRIPTION OF THE DRAWINGS

Example embodiments will be described with reference to the accompanying drawings, which are described below briefly.

FIG. 1 is a block diagram of an example environment in which several aspects of the present invention can be implemented.

FIG. 2 is a flowchart illustrating operations in a wireless node enabling the detection of intrusion in an embodiment of the present invention.

FIG. 3 is a flowchart illustrating the operation of a sentinel enabling the detection of intrusion in an embodiment.

FIGS. 4A and 4B are block diagrams illustrating example intrusion scenarios.

FIG. 5 is a block diagram of a sentinel device/wireless node in an embodiment in which various features are operative by execution of software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A wireless node implemented according to an aspect of the present invention examines a received data packet containing its address in a destination address field for the presence of one or more anomalies, and transmits a message packet upon determining presence of an anomaly. A sentinel device processes the message packet to determine whether a transmitter of the data packet represents a possible intruder, and causes a spy routine to be activated in the wireless node. A spy routine may engage the potential intruder in further conversation to continue investigation as to whether the transmitter is indeed an intruder.

Since the wireless node may operate normally (normal operations) until an anomalous condition/event occurs, the additional power consumption for detection of intrusion may be reduced. Such an approach may be desirable in environments where power consumption constraints may be present.

A wireless node provided according to another aspect of the present invention operates to transport packets to end devices, in addition to examining the transported packets for anomalies. Due to the implementation of both the features in a single device, the number of components in a wireless network can potentially be reduced. The coverage in a wireless network for intrusion detection may also be enhanced due to such a feature.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

### 2. Example Environment

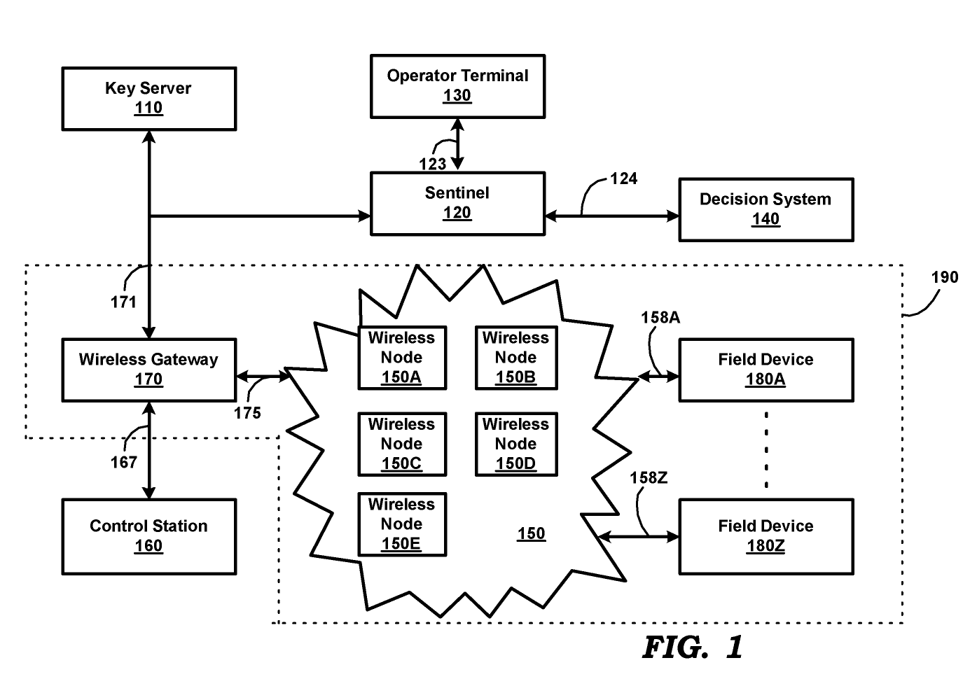

FIG. 1 is a block diagram of an example environment in which several aspects of the present invention can be implemented. The diagram is shown containing key server 110, sentinel 120, operator terminal 130, decision system 140, repeater system 150, control station 160, gateway 170, and field devices 180A and 180B.

Merely as an example, the environment of FIG. 1 is shown as corresponding to an industrial process control system, and is shown containing only representative systems for illustration. Real-world environments may contain many more systems/components as will be apparent to one skilled in the relevant arts. Further, implementations in any wireless network environment in general are also contemplated to be within the scope and spirit of several aspects of the present invention. In FIG. 1, paths 123, 124, 167, and 171 may be wired paths, while paths 175, 158A-158Z, and communication paths (not shown) between wireless nodes 150A-150Z are wireless paths. Each component of FIG. 1 is described in detail below.

Wireless field devices 180A-180Z represent field devices (such as temperature sensors, pressure sensors, actuators etc) used for monitoring/controlling the operation of the industrial process control environment, and operate according to control commands received from control system 150. In an embodiment, wireless field devices 180A-180Z provide process values (e.g., temperature, pressure etc) of various equipment (not shown) being controlled to control system 160, or accept control values (to control output devices such as actuators) from control system 160. In an embodiment (frequency hopping spread spectrum, FHSS), wireless field devices 180A-180Z are allocated corresponding time slots (by a corresponding component implemented part of control station 160), during which they may transmit/receive communication data packets. Though not shown, the environment may contain wireless field devices connected by wire based paths as well.

Repeater system 150 is shown containing wireless nodes 150A-150E which operate as intermediary (repeater/relay) nodes in the communication path between control station 160 and wireless field devices 180A-180Z. The communication path between control station 160 and a wireless field device may contain one or more wireless nodes as repeater/relay nodes. Each wireless node may “listen” to data packets being transmitted on the wireless medium to check for data packets intended for itself (either as an end recipient based on a destination network address field in the data packet, or as a repeater node based on the destination MAC level address field in the data packet).

Each of wireless nodes 150A-150E may be provided information about the specific time slots during which corresponding wireless field devices may transmit/receive data packets during such transporting (of data packets between control station 160 and wireless field devices) in case of FHSS communication technologies between the field devices and the wireless nodes. Wireless nodes may communicate with each other potentially using other protocols such as 802.11, well known in the relevant arts.

Gateway 170 and wireless field devices may be viewed as end systems/devices, and the wireless nodes operate to transport packets between the end systems/devices. In general, the specific node to which a packet is finally destined to, is determined by the corresponding network address and a wireless node may forward the packet to a next node or destination device according to the network address contained in the packet. As described in sections below, a wireless node (implemented as a single physical unit) may operate to assist in intrusion detection as well, while transporting packets, according to an aspect of the present invention.

Control station 160 transmits control values to output devices (e.g., actuators) among field devices 180A-180Z via gateway 170 and one or more wireless nodes 180A-180Z (through corresponding paths 167, 175, 158A-158Z and paths (not shown) between wireless nodes 150A-150Z).

Control station 160 receives process values from input devices (e.g., temperature sensors) among field devices 180A-180Z also via one or more wireless nodes 180A-180Z (through corresponding connection paths 165, 158A-158Z and paths (not shown) between wireless nodes 150A-150Z). Control station 160 may generate the control values in accordance with a desired control strategy.

Although not shown, control station 160 may be connected to various other components such as a database server, management server, operator terminals etc., facilitating the generation and operation of control strategies noted above. Control station 160 also allocates time slots (for transmission/reception) and network addresses for each of the field devices 180A-180Z during initialization in case of FHSS type technologies noted above.

Wireless gateway 170 receives commands (or other data) from control station 160, and transmits the commands over a wireless medium to wireless field devices 110A-110Z via repeater system 150. Similarly, wireless gateway 170 receives process values (such as noted above) from wireless field devices 180A-180Z over the wireless medium via repeater network 150, and provides them to control system 160.

Wireless gateway 170, repeater system 150 and field devices 180A-180Z form a wireless network, referred to as wireless network 190 henceforth, and is indicated by the dotted region in FIG. 1.

Key server 110 generates keys (example according to a symmetric key encryption approach) used to encrypt/decrypt data transferred among control station 160, wireless nodes 150A-150Z and field devices 180A-180Z, and forwards the keys to wireless gateway 170, which in turn forwards the appropriate keys to the corresponding devices (wireless nodes/field devices). Key server 110 also provides key information to sentinel 120 (via wired path 171) Key Server 110 and decision system 140, although shown separately, may also be implemented as a part of control station 160.

Operator terminal 130 provides a suitable user interface (e.g., display/keyboard) on which sentinel 120 may issue an alarm (via path 123) if intrusion is suspected/detected. An operator may then manually issue investigation commands (in addition to the automated intrusion detection process) via operator terminal 130 to further determine the nature of the intrusion, and to initiate action to remove the intruder from the operating zone of network 190 . However, at least some of the intrusions can be determined without any operator intervention.

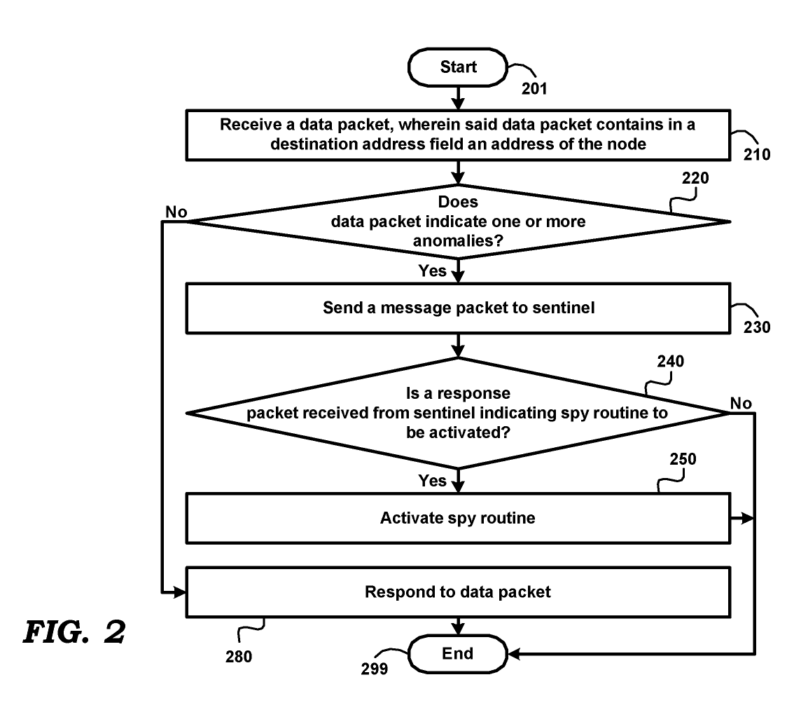

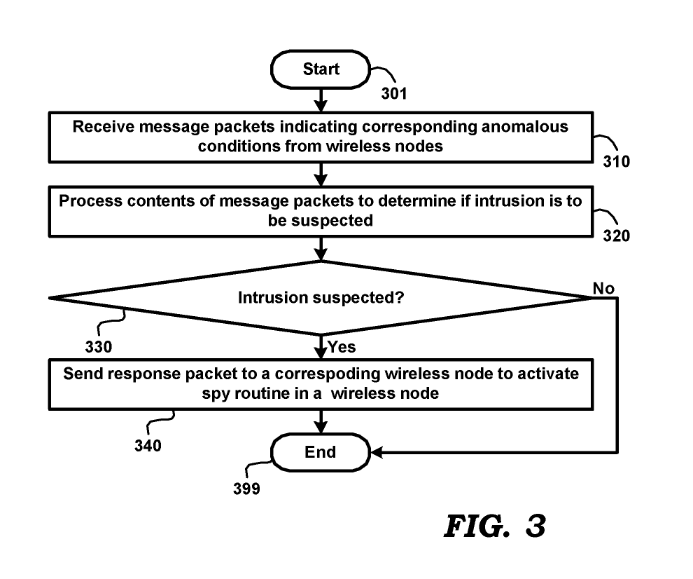

Sentinel (sentinel device) 120 may receive (via gateway 170) message packets from wireless nodes 150A-150E (on detection of anomalous behavior in the network), and in conjunction with decision system 140 operates to process the message packets to determine if intrusion is indicated. The manner in which intrusion in wireless network 190 may be detected is described next with respect to flowcharts of FIGS. 2 and 3.

### 3. Intrusion Detection

FIG. 2 is a flowchart illustrating the operations in a wireless node (in repeater system 150) enabling the detection of intrusion in an embodiment of the present invention. The flowchart is described with respect to FIG. 1, and in relation to wireless node 150A, merely for illustration. It must be understood that similar features may be operational in the other wireless nodes (150B-150E), in other environments and other components as well. Furthermore, the steps are described in a specific sequence merely for illustration.

Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, wireless node 150A receives a data packet with the data packet containing a value in a destination address field indicating that the packet is directed to wireless node 150A, i.e., the intended recipient of the data packet is wireless node 150A. It may be appreciated that due to the broadcast nature of the wireless medium, several packets would be received (at the antenna of) by wireless node 150, but whether a packet is directed to a specific wireless or not depends on values in the destination address field.

In general, a wireless node can be assigned different addresses at different layers (e.g., medium access control layer, network layer, object identifier etc.). Thus, when a packet contains the address of the wireless node 150A in the destination address field (according to the convention at the corresponding protocol layer), the packet is deemed to be directed to the wireless node. Though unicast packets (address indicating a single machine) are commonly received, multicast or broadcast addresses can also be used to direct a packet to wireless node 150A. Control then passes to step 220.

In step 220, wireless node 150A checks the data packet for one or more anomalies. An anomaly generally refers to deviation from normal expected behavior, and deviations which could indicate intrusion would be of interest. Packets may be checked for specific ones of those anomalies which can lead to a conclusion of intrusion. In an embodiment wireless node 150A checks for MAC (Medium access control) level anomalies, network layer level anomalies, and security layer level anomalies described in detail below. If wireless node 150A detects one or more anomalies, control passes to step 230, else control passes to step 280.

In step 230, wireless node 150A sends a message packet to sentinel 120. In an embodiment, the message packet contains the nature of the anomalous condition in the data packet (received in step 210), time of receipt of the data packet, address of the device that transmitted the data packet, and the received data packet itself. In other embodiments, wireless node 150A may transmit just the received data packet if any anomaly is noted. Control then passes to step 240. In general, the information required for further processing by sentinel 120 may need to be sent.

In step 240, if a response packet (in response to the message packet sent in step 230) indicating that the transmitter of the data packet may potentially be an intruder, is received by wireless node 150A, control passes to step 250. The response packet may be generated by sentinel 120 as described below with respect to FIG. 3. If a response is not received within a specified interval or if a received response does not indicate that the transmitter is potentially an intruder, control passes to step 299. In general, an intruder represents any systems transmitting unauthorized (or undesirable otherwise) packets to the wireless network.

In step 250, wireless node 150A activates a spy routine which enables further investigation into possible intrusion (and thus determination of intrusion with a greater level of probability) as described in sections below. In an embodiment, upon activation of the spy routine, the corresponding wireless node transmits a “challenge question” to intruder 410. The challenge question may be stored in advance in the wireless node.

In another embodiment, the wireless node may transmit an encrypted bit stream, and request for the bit stream to be returned in decrypted form. Non-receipt of a correct (expected) response from intruder 410 further strengthens the earlier determination of intrusion. The above noted investigative techniques by the spy routine are provided merely as examples, and are not exhaustive. Any appropriate query and expected response pattern may be employed to determine intrusion with greater certainty. Control then passes to step 299 in which the flowchart ends.

In step 280, responds to the data packet as if it were a normal (not intrusion) data packet. Wireless node 150A may, for example, forward the data packet to a next device in the transmission path (another wireless node, a field device, or control station 160). Control then passes to step 299 in which the flowchart ends.

The flowchart of FIG. 2 is repeated to process each (received) data packet. Although the anomalous condition is described as being performed based on a single packet, it should be appreciated that the anomalous condition can be determined based on multiple packets, potentially received in sequence from the same transmitter (or transmitting external wireless node).

In addition, although, wireless node 150A was described as receiving the response packet and activating the spy routine in steps 240 and 250, sentinel 120 may send the response packet to any of wireless nodes 150A-150E causing the spy routine to be activated in the corresponding node instead.

It may be further appreciated that the operation of wireless nodes needs to be consistent with the operation of sentinel 120. Accordingly the description is continued with respect to an example embodiment of sentinel 120.

### 4. Sentinel

FIG. 3 is a flowchart illustrating the operation of sentinel 120 enabling the detection of intrusion in an embodiment. Again, the flowchart is described with respect to FIGS. 1 and 2 merely for illustration. It must be understood that similar features may be implemented in other environments and other components as well. Furthermore, the steps are again described in a specific sequence merely for illustration. The flowchart starts in step 301, in which control passes immediately to step 310.

In step 310, sentinel 120 receives a message packet indicating one or more anomalous conditions from one (or more) of wireless nodes 150A-150E. The anomalies may be detected based on a data packet received by the corresponding wireless node, and may correspond to MAC layer level anomalies, network layer level anomalies, and security layer level anomalies described in detail below. The message packet may contain the nature of the anomaly(ies), time of receipt of the data packet (by the wireless node), address of the device that transmitted the data packet, and the received data packet itself. Alternatively, the message packet may contain only a copy of the received data packet. Control then passes to step 320.

In step 320, sentinel 120 processes the contents of the message packet to determine if intrusion is to be suspected. In an embodiment, sentinel 120 maintains a record of occurrences of anomalous events potentially from all wireless nodes, and may determine intrusion based on statistical techniques. Sentinel 120 may also determine intrusion based on a set of decision rules (e.g., a SNORT decision engine, available at Snort Store, c/o Artesian City Marketing, 907 S. Memorial Dr. Prattville Ala. 36067334 361-2133 or 866 278-1994) that specify the manner in which intrusion is to be determined. Alternatively, sentinel 120 may forward the message packet to decision system 140 which may perform the processing to determine intrusion based on probabilistic and rule-based techniques noted above.

If intrusion is suspected, sentinel 120 may also determine from the message packet the transmission route from the suspected intruder node (transmitter of the data packet containing the anomaly), and identifies a wireless node (one of wireless nodes 150A-150Z) nearest to the suspected intruder. The approximate/relative locations of the wireless nodes 150A-150Z may be provided to sentinel 120 in advance (for example, by control station 160 or an operator at operator terminal 130 or some other configuration data). Control then passes to step 330.

In step 330, if processing in step 320 is determined to indicate possible intrusion, control passes to step 340. If processing does not indicate possible intrusion (for example, if it is determined instead that the anomaly was due to a maintenance issue), sentinel 120 may take no further actions, and control passes to step 399 in which the flowchart ends. (During maintenance, a wireless node may be temporarily unavailable for normal operation, and hence its address would not normally be received by other operational nodes. Consequently, if the node undergoing maintenance inadvertently transmits a packet, this may be noted as an anomaly by a wireless node, but determined not to be a potential intruder at sentinel 120).

In step 340, sentinel 120 sends a response packet to the wireless node nearest to the suspected intruder to cause a spy routine in that wireless node to be activated. The response packet may thus be seen as a request for further investigation (RFI), and may be provided through a secure channel (for example, by encrypting the contents of the response packet using symmetric keys provided by key server 110 ) to the corresponding wireless node. Sentinel 120 also provides the address of the suspected intruder to the wireless node. In an embodiment, sentinel 120 may also provide an ‘intrusion’ alert to an operator (e.g., via operator terminal 130) along with a zone/location information of the suspect intruder (based on the transmission route information contained in the message packet, as described below). Control then passes to step 399, in which the flowchart ends.

From the above description, it may be appreciated that a wireless node indicates anomalous condition based on one or more packets directed to the wireless nodes. The sentinel may determine that a transmitter of such packets is a potential intruder based on reports of potentially multiple anomalous conditions, possibly from different wireless nodes. The spy node may then engage the potential intruder in further communication to confirm that the potential intruder indeed needs to be treated as an intruder. It may be appreciated that the probability of a transmitter being an intruder is enhanced gradually as the processing progresses from wireless node to sentinel to spy routine.

It may be further noted that the steps of flowcharts of FIGS. 2 and 3 may operate concurrently. Further, subsequent to step 340, sentinel 120 may get a response for the RFI from the corresponding wireless node (based on a result of step 250 in the flowchart of FIG. 2). There could be subsequent RFIs and responses to the RFIs. Sentinel 120 may process the responses to the RFIs to determine intrusion with a greater level of certainty. Alternatively, such determination may be performed by decision system 140. Sentinel 120 may also notify/trigger an alert to an operator via operator terminal 130.

It may also be appreciated from the flowcharts of FIG. 2 and 3, that a wireless node operates normally (normal operations) until an anomalous condition/event occurs. Thus, less power may be wasted monitoring for intrusion until detection of an anomalous event. Such an approach may be desirable in environments where power consumption constraints may be present. As an example, wireless nodes 150A-150E may be battery operated devices operating as part of an industrial process control system. Consequently, it is desirable that they consume minimal power.

The operation of the flowcharts described above is illustrated below with respect to example intrusion scenarios. First, a description of some anomalous conditions/events noted above is provided.

### 4. Anomalous Conditions

Some anomalous conditions (events) that may cause a wireless node to send a message packet to sentinel 120 indicating possible intrusion are described below.

First, it is noted that, a wireless node (such as wireless node 150A) may first check the destination MAC address in a received data packet. If the destination MAC address matches the wireless node's own MAC address, then the wireless node may check the destination network address in the packet. If both the destination MAC and network addresses match the wireless node's own MAC and network addresses, the wireless node may conclude that it is the final recipient (intended recipient) of the data packet. The wireless node may then check the security level parameters (or fields) in the data packet.

However, if the destination network address is different from the wireless device's own network address (but the destination MAC address matches the device's MAC address) the wireless device may conclude that the data packet is intended for some other wireless device whose MAC address matches the destination network address, and thus that the data packet is to be forwarded to that wireless device. Thus, it may be noted that a wireless device may detect anomalies at the MAC layer, network layer or security layer levels.

It is briefly noted here that a possible intruder may pose either as a ‘legitimate’ wireless node or as a wireless field device according to corresponding wireless technologies. For example, the intruder may “listen” to data being transmitted on the wireless medium to obtain addresses of wireless nodes/wireless field devices located in the vicinity (within a communication range), and use that information to send unauthorized packets to the wireless network.

Irrespective of the underlying reasons, here are some representative anomalies that suggest possible intrusions.

a) Packet is not expected from transmitting device:

As noted above, wireless field devices are allocated time slots by control station 160 in which they may transmit/receive communication/data packets, and each of wireless nodes 150A-150E may be provided information about the specific time slots during which corresponding wireless field devices may transmit/receive data packets. Thus, if a wireless node notes that a received data packet was received in a non-scheduled time slot (for example, from an intruder posing as a wireless field device), i.e., there is no time slot allotted for the data packets of the transmitter, this may suggest possible intrusion. This anomaly represents a MAC layer level anomaly.

b) Data packet received at a wireless node does not contain a “valid” destination address of a destination device (i.e., a node that is to be the final recipient of the data packet):

A packet may be received with MAC level address of wireless node 150A, but the address at higher level protocols (e.g., network layer) may not match that of wireless node 150A or the other wireless nodes 150B-150E, e.g., based on a network address of the network to which all the wireless nodes belong.

c) Packet size (e.g., number of bytes) of data packet is greater than or less than an expected size:

In general, many networks (or corresponding technology/standard) set maximum and minimum sizes of a data packet and if the size of the received packet is not within such limits, the anomaly represents a network layer level anomaly.

d) Received data packet contains a wrong/incorrect Message Integrity Code (MIC):

A MIC is a unique code/number that may be contained in every data packet transmitted on network 190. This (reception of a invalid number) anomaly represents a security layer level anomaly.

e) Nonce anomalies:

Each data packet transmitted on network 190 may be designed to have a field for a Nonce number, which is generally a number with a time-varying value. If a data packet has a Nonce value less than a present value for the network, this may potentially indicate that some ‘rogue’ device (intruder) is trying to retransmit a data packet by ‘listening’ to data traffic in the wireless medium, and thus may represent an anomaly. The Nonce value may also be randomly generated. This anomaly represents a security layer level anomaly.

f) Flip-flop of connection status:

An intruder may send packets which have the effect of establishing and breaking (security) connections. This anomaly represents a security layer level anomaly.

It should be appreciated that several other anomalies as suited for the specific environment may be checked for, without departing from the scope and spirit of several aspects of the present invention, as will be apparent to one skilled in the relevant arts by reading the disclosure herein.

Thus, an intrusion detection system (containing nodes, sentinel and decision system in the above example) may be implemented to detect intrusions based on all such anomalies.

Example intrusion scenarios are described next to illustrate the operation of the intrusion detection system.

### 5. Example Intrusion Scenarios

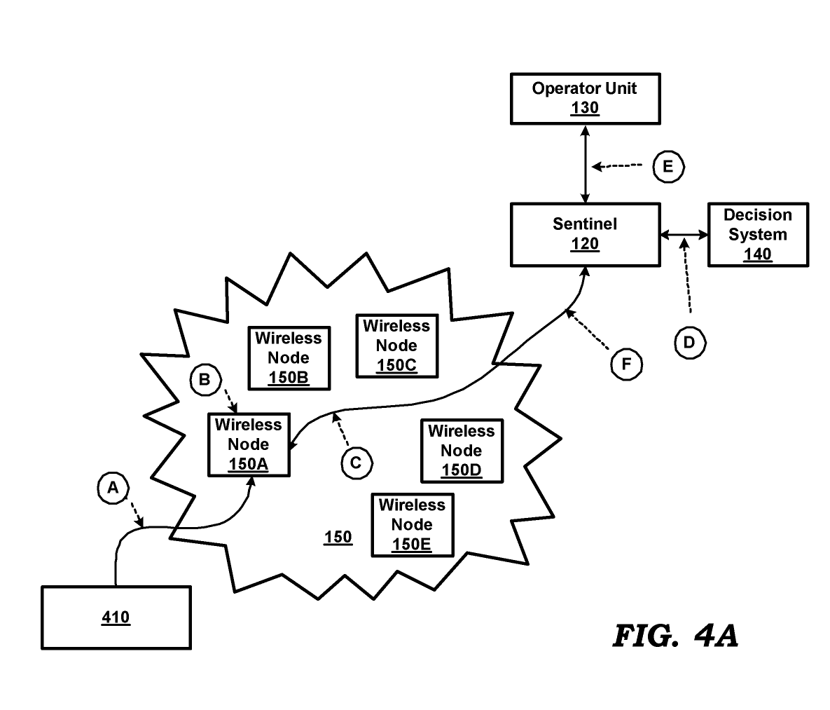

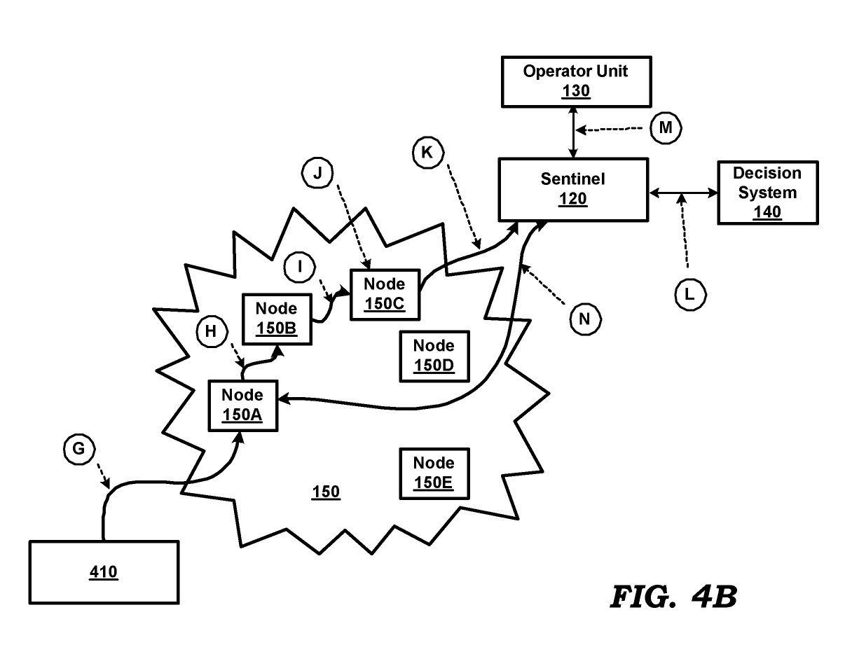

FIG. 4A is a block diagram illustrating an example intrusion scenario. Only those components of FIG. 1 necessary for an understanding of the following description are shown.

Device 410 is assumed to be an intruder (referred to henceforth as intruder 410, and also as transmitter in some instances), and is shown as transmitting a data packet (denoted in FIG. 4A by ‘A’) to wireless node 150A. Intruder 410 may either pose as a wireless node or as a wireless field device.

Wireless node 150A may examine the data packet and determine that the data packet was received in a “wrong” time slot (i.e., data packet was not expected), and thus that an anomalous condition is present (denoted by ‘B’). This scenario may occur if intruder 410 posing as a wireless field device transmits a data packet to wireless node 150A in a ‘wrong’ time slot.

In a different scenario, intruder 410 posing as another wireless node may transmit a data packet with a destination MAC address same as wireless node 150A's MAC address, but an invalid network address (of a destination device) to which the data packet is to be relayed/forwarded by wireless node 150A. In this scenario, wireless node 150A may note that the destination network address is invalid, and hence as representing an anomaly.

Wireless node 150A then transmits a message packet to sentinel 120 (denoted by ‘C’). Alternatively, instead of transmitting a message packet after detection of a single anomalous event, wireless node 150A may wait for detection of multiple anomalous events, and then transmit the message packet.

Sentinel 120 forwards the message packet to decision system 140, and in response receives notification that intrusion is suspected (denoted by ‘D’). Alternatively, sentinel 120 may itself make a determination of intrusion.

Sentinel 120 forwards an alert to an operator that intrusion is suspected (denoted by ‘E’). Sentinel 120 also sends a response packet to wireless node 150A (denoted by ‘F’). Receipt of the response packet activates a spy routine in wireless node 150A. The spy routine enables further investigation into the intrusion as noted above.

FIG. 4B is a block diagram illustrating another example intrusion scenario. Again, device 410 is assumed to be an intruder, and is shown transmitting a data packet (denoted in FIG. 4B by ‘G’) to wireless node 150C, relayed via wireless nodes 150A and 150B, i.e., the data packet has the address of wireless node 150A in a destination network address field.

Wireless node 150A examines the data packet at a MAC and network layer level and determine no anomalies. Wireless node 150A then timestamps the packet with its own MAC address and network layer address, and forwards the data packet to wireless node 150B (denoted in FIG. 4B by ‘H’). Wireless node 150B similarly examines the data packet at a MAC and network layer level and determines no anomalies. Wireless node 150B also timestamps the packet with its own MAC address and IP-address, and forwards the data packet to wireless node 150C (denoted in FIG. 4B by ‘I’).

Wireless node 150C determines a security layer level anomaly in the data packet. For example, wireless node 150C may note that the data packet has an incorrect MIC (message integrity code). Determination of this anomaly is denoted by “J” in FIG. 4B.

Wireless node 150C then transmits a message packet to sentinel 120 (denoted by ‘K’), with the message packet containing the type of anomaly (incorrect MIC in this example), time at which the packet was received, network address of intruder 410, the data packet itself and the routing information containing the route (transmission route) followed by the data packet in traveling from the intruder to wireless node 150C. Any packet format can be used to send such information. Alternatively, instead of transmitting a message packet after detection of a single (instance of) anomalous event, wireless node 150C may wait for detection of multiple (instances of) anomalous events, and then transmit the message packet.

Sentinel 120 forwards the message packet to decision system 140, and in response receives instruction that intrusion is suspected (denoted by ‘L’). Alternatively, sentinel 120 may itself make a determination of intrusion. Since the data packet when received at sentinel 120 has the routing information (transmission route and addresses of devices in the transmission route from intruder 410 to sentinel 120), sentinel 120 can determine which wireless node is located nearest to intruder 410.

Generally, a wireless node that is the first recipient (first node in the communication route to receive the packet) is the wireless node nearest to the transmitter (originator) of the data packet. The physical location (e.g., geographical identification or coordinates) of each wireless node may be provided in advance to sentinel 120 (via operator unit 130) by an operator/user based on an installation/deployment chart. Referring to FIG. 4B, sentinel 120 determines that intruder 410 is located in a zone close to wireless node 150A, with the area of the zone generally being determinable based on the sensitivity of the receiver circuitry of wireless node 150 (which is generally known in advance).

Sentinel 120 sends an alert to an operator that intrusion is suspected (denoted by ‘M’), along with the location (or zone) in which intruder 410 may be present. Sentinel 120 also sends a response packet to wireless node 150A (denoted by ‘N’). Receipt of the response packet activates a spy routine in wireless node 150A. The spy routine enables further investigation into the intrusion as described in sections below.

Sentinel 120 and the corresponding wireless node in which a spy routine is activated may then operate to further investigate whether intrusion is to be declared. Once intrusion is determined to be present with a probability greater than a threshold level, appropriate corrective action may be initiated to prevent intruder 410 from affecting wireless network 190.

As an example, the wireless node executing the spy routine may block (by not forwarding it to a next node/device) data packets received from the intruder. This may prevent network flooding and denial of service.

As another example, encrypt/decrypt keys (generated by key server 110) may be changed (updated) at shorter time intervals (greater frequency) on determination of intrusion.

As yet another example, manual/operator intervention may be initiated to remove the intruder from the operating zone of network 190.

Each of wireless nodes 150A-150E and sentinel 120 can be implemented in a combination of one or more of hardware, software and firmware. In general, when throughput performance is of primary consideration, the implementation is performed more in hardware (e.g., in the form of an application specific integrated circuit). When cost is of primary consideration, the implementation is performed more in software (e.g., using a processor executing instructions provided in software/firmware). Cost and performance can be balanced with a desired mix of hardware, software and/or firmware. An embodiment of a wireless node and sentinel 120 implemented substantially in software are described below.

### 7. Software Implementation

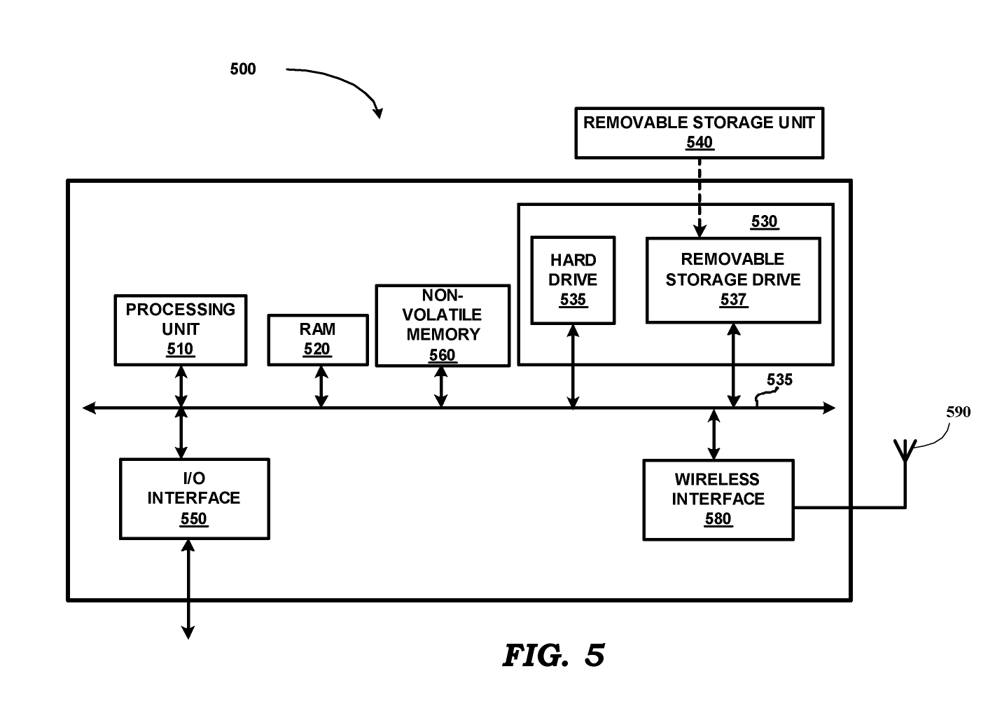

FIG. 5 is a block diagram illustrating the details of a system in one embodiment. The system may correspond to sentinel 120 or wireless node 150A. A common description of both sentinel and wireless node is provided for conciseness, while noting the differences. System 500 is shown containing processing unit 510, random access memory (RAM) 520, storage 530, input/output (I/O) interface 550, non-volatile memory 560, wireless interface 580 and antenna 590. Each component is described in further detail below.

I/O interface 550 provides an interface to receive and send data to external devices over wired paths, and can be used, for example, to enable an operator/user to provide inputs and receive outputs in the case of sentinel 120, or perform diagnostic tests prior to deployment in case of wireless node 150A. Specifically, I/O interface 550 may be used to provide an alert to an operator terminal about a possible intrusion.

Wireless interface 580 enables system 500 to send and receive data over a wireless medium (via antenna 590) consistent with a desired communication protocol. Wireless interface 580, and I/O interface 550 can be implemented in a known way.

RAM 520 and non-volatile memory 530 may together be referred to as a memory. RAM 520 may receive instructions and data on path 550 from non-volatile memory 530, and provides the instructions to processing unit 510 for execution. Non-volatile memory 530 may store the software instructions and data, which enable system 500, as applicable, to provide several features in accordance with the present invention, and may be implemented, for example, as a read-only memory (ROM) or flash memory. RAM 520 and non-volatile memory 530 are examples of a computer (machine, in general) readable medium.

Storage 530 may contain units such as hard drive 535 and removable storage drive 537, and may also store the software instructions and data, which enable system to provide several features in accordance with the present invention.

In the case of sentinel 120, some or all of the data and instructions may be provided on removable storage unit 540, and the data and instructions may be read and provided by removable storage drive 537 to processing unit 510 via RAM 520. Floppy drive, magnetic tape drive, CD-ROM drive, DVD Drive, Flash memory, removable memory chip (PCMCIA Card, EPROM) are examples of such removable storage drive 537.

In general, computer (or generally, machine) readable medium refers to any medium from which processors can read and execute instructions. The medium can be randomly accessed (such as RAM 520 or non-volatile memory 530), volatile, non-volatile, removable or non-removable, etc. While the computer readable medium is shown being provided from within system 500 for illustration, it should be appreciated that the computer readable medium can be provided external to system 500 as well.

Processing unit 510 may contain one or more processors. Some of the processors can be general purpose processors which execute instructions provided from RAM 520. Some can be special purpose processors adapted for specific tasks. The special purpose processors may also be provided instructions from RAM 520. In general processing unit 510 reads sequences of instructions from various types of memory medium (including RAM 520, storage 530 etc.), and executes the instructions to provide various features of the present invention.

### 8. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. An intrusion detection system comprising:
a plurality of wireless nodes operating to transport packets between end devices over a wireless medium, wherein each wireless node in said plurality of wireless nodes examines a received data packet for the presence of one or more anomalies, and transmits a message packet upon the presence of said one or more anomalies; and
a sentinel device processing said message packet to determine whether a transmitter of said received data packet is a potential intruder, and causing a spy routine to be activated if said transmitter is determined to be said potential intruder,
wherein operation of said spy routine communicates further with said transmitter to facilitate a determination of whether said transmitter is an actual intruder.

2. The intrusion detection system of claim 1, wherein each wireless node examines only a set of packets for said one or more anomalies, wherein each of said set of packets has a destination address indicating that the packet is directed to the wireless node.

3. The intrusion detection system of claim 2, wherein a first node determines an anomaly by examining a first packet contained in said set of packets, wherein said first packet contains the address of said first node in said destination address field.

4. The intrusion detection system of claim 1, wherein a second wireless node contained in said plurality of wireless nodes detects a first anomaly and sends a first message to said sentinel to indicate presence of said first anomaly, wherein said sentinel sends a reply packet to said second wireless node to activate said spy routine.

5. The intrusion detection system of claim 1, wherein a third wireless node contained in said plurality of wireless nodes detects a third anomaly and sends a third message to said sentinel to indicate presence of said third anomaly, wherein said sentinel sends a reply packet to a fourth wireless node, different from said third wireless node, to activate said spy routine.

6. The intrusion detection system of claim 5, wherein said sentinel determines that said fourth wireless node is closer than said third wireless node to said transmitter.

7. The intrusion detection system of claim 1, wherein said sentinel communicates with a decision system to determine that said transmitter is said potential intruder.

8. The intrusion detection system of claim 1, wherein said one or more anomalies comprises one or more of reception of said data packet in non-scheduled time slot, an absence of a destination address in said data packet, an incorrect packet size of said data packet, an incorrect message integrity code in said data packet, an incorrect nonce value in said data packet, observation of repeated change in a connection status.

9. The intrusion detection system of claim 1, wherein said end devices comprise a control station and a plurality of wireless field devices, wherein said control station and said plurality of field devices are designed to implement a corresponding control strategy in a process control plant.

10. The intrusion detection system of claim 1, wherein said sentinel alerts a human operator to intrusion by said potential intruder if said processing of said message packet determines that said transmitter of said received data packet is a potential intruder, said sentinel also providing a location information of said intruder to said human operator.

11. A method of detecting intrusion by a transmitter in a wireless network, said wireless network comprising a plurality of wireless nodes, said method being implemented in each of said plurality of wireless nodes, said method comprising:
receiving a data packet from said transmitter in a first wireless node, wherein said data packet is directed to said first wireless node, wherein said first wireless node is contained in said plurality of wireless nodes;
examining in said first wireless node said data packet to determine presence of one or more anomalies; and
sending from said first wireless node a message packet to a sentinel device if said one or more anomalies are present.

12. The method of claim 11, further comprising:
receiving a response packet from said sentinel; and
activating operation of a spy routine upon a reception of said response packet.

13. The method of claim 12, further comprising:
receiving a plurality of packets; and
forwarding each of said plurality of packets to a next wireless node or an end device to which the packet is destined to.

14. The method of claim 12, wherein said data packet contains an address of said first wireless node in a destination address field.

15. The method of claim 12, further comprising communicating further with said transmitter to facilitate a determination of whether said transmitter is an actual intruder.

16. A method of detecting intrusion by a transmitter in a wireless network, said wireless network comprising a plurality of wireless nodes, said method being implemented in a sentinel device, said method comprising:
receiving a message packet from a first wireless node contained in said plurality of wireless nodes, wherein said message packet indicates one or more anomalies observed in a data packet received by said first wireless node; and
transmitting a response packet indicating that a spy routine is to be activated to investigate further if a processing of said message packet indicates that said transmitter is a potential intruder.

17. The method of claim 16, further comprising alerting a human operator to intrusion by said transmitter if said processing of said message packet indicates that said transmitter is a potential intruder.

18. The method of claim 16, further comprising:
determining a physical location of said potential intruder; and
providing information indicating said physical location to an operator.

19. The method of claim 18, wherein said determining comprises:
examining a content of said message packet to determine a first wireless node which received said message packet from said potential intruder;
checking a location information to identify a zone in which said first wireless node is located, wherein said physical location comprises said zone.

20. The method of claim 16, further comprising:
determining a closest one of said plurality of wireless nodes to said transmitter by examining said message packet, wherein said response packet is designed to cause said closest one of said plurality of wireless nodes to execute said spy routine.

21. The method of claim 20, wherein said message packet contains a plurality of time stamps, each from a corresponding wireless node forwarding said data packet., wherein said closest wireless node is the wireless node with the earliest time stamp.

22. A machine readable medium storing one or more sequences of instructions for enabling a wireless node in a wireless network to detect intrusion by a transmitter in said wireless network, said wireless network containing a plurality of wireless nodes, said wireless node being contained in said plurality of wireless nodes, wherein execution of said one or more sequences of instructions by one or more processors contained in said wireless node causes said wireless node to perform the actions of:
receiving a data packet from said transmitter, wherein said data packet is directed to said wireless node;
examining said data packet to determine presence of one or more anomalies; and
sending a message packet to a sentinel device if said one or more anomalies are present.

23. The machine readable medium of claim 22, wherein said wireless node receives a response packet from said sentinel, and activates operation of a spy routine upon a reception of said response packet.

24. The machine readable medium of claim 22, wherein said wireless node receives a plurality of packets, and forwards each of said plurality of packets to a next wireless node contained in said plurality of wireless nodes or an end device to which said plurality of packets are destined to.

25. The machine readable medium of claim 22, wherein said data packet contains an address of said wireless node in a destination address field.

26. A machine readable medium storing one or more sequences of instructions for enabling a sentinel device to detect intrusion by a transmitter in a wireless network, said sentinel device being connected to said wireless network over a wireless medium, said wireless network containing a plurality of wireless nodes, wherein execution of said one or more sequences of instructions by one or more processors contained in said sentinel device causes said sentinel device to perform the actions of:
receiving a message packet from a first wireless node contained in said plurality of wireless nodes, wherein said message packet indicates one or more anomalies observed in data packets received by said first wireless node; and
transmitting a response packet indicating that a spy routine is to be activated to investigate further if a processing of said message packet indicates that said transmitter is a potential intruder.

27. The machine readable medium of claim 26, wherein said sentinel device alerts a human operator to intrusion by said transmitter if said processing of said message packet indicates that said transmitter is a potential intruder.

28. The machine readable medium of claim 26, wherein said sentinel device determines a physical location of said potential intruder, and provides information indicating said physical location to an operator.

29. The machine readable medium of claim 28, wherein said determining a physical location comprises:
examining a content of said message packet to determine a first wireless node which received said message packet from said potential intruder;
checking a location information to identify a zone in which said first wireless node is located, wherein said physical location comprises said zone.

30. The machine readable medium of claim 26, wherein said sentinel device determines a closest one of said plurality of wireless nodes to said transmitter by examining said message packet, wherein said response packet is designed to cause said closest one of said plurality of wireless nodes to execute said spy routine.
